(19) United States
(12) Patent Application Publication
(10) Pub. No.: US 2026/0094981 A1
(43) Pub. Date: Apr. 2, 2026

(54) CONDUCTOR TERMINAL, ACTUATION LEVER, AND SET FORMED THEREOF

(71) Applicant: WAGO Verwaltungsgesellschaft mbH, Minden (DE)

(72) Inventors: Frank SELLKE, Minden (DE); Henry STOLZE, Bad Frankenhausen (DE)

(73) Assignee: WAGO Verwaltungsgesellschaft mbH, Minden (DE)

(21) Appl. No.: 19/368,543

(22) Filed: Oct. 24, 2025

Related U.S. Application Data
(63) Continuation of application No. PCT/EP2024/061234, filed on Apr. 24, 2024.

(30) Foreign Application Priority Data
Apr. 26, 2023 (DE) 20 2023 102 239.1

(51) Int. Cl. H01R 4/48; H01R 9/24

(52) U.S. Cl. CPC H01R 4/483; H01R 4/4821; H01R 9/2416

(57) ABSTRACT

A conductor connection terminal including a housing and at least one first spring-loaded clamping connection, situated in the housing. A first clamping spring connects a first electrical conductor via elastic force. Provided is also an actuating lever for such a conductor connection terminal, and a set made up of at least one conductor connection terminal and the actuating lever.

This nonprovisional application is a continuation of International Application No. PCT/EP2024/061234, which was filed on Apr. 24, 2024, and which claims priority to German Patent Application No. 20 2023 102 239.1, which was filed in Germany on Apr. 26, 2023, and which are both herein incorporated by reference.

### BACKGROUND OF THE INVENTION

### Field of the Invention

The invention relates to a conductor connection terminal including a housing and at least one first spring-loaded clamping connection, situated in the housing, having a first clamping spring for connecting a first electrical conductor by means of elastic force. The invention further relates to an actuating lever for such a conductor connection terminal, and to a set made up of at least one conductor connection terminal and an actuating lever of the above-mentioned type.

### Description of the Background Art

Conductor connection terminals with spring-loaded clamping connections are generally known and widely used, in particular having an integrated actuating lever, for example using the applicant's 221 Series conductor connection terminals.

### SUMMARY OF THE INVENTION

It is therefore an object of the invention to provide a miniaturized conductor connection terminal, in particular for electrical conductors, having a very small conductor cross section.

For a conductor connection terminal of the type stated at the outset, this object is achieved, in an example, in that the housing on its outer side has a first receiving contour to which a swivelable actuating lever, which is configured for manual actuation of the first clamping spring, is latchable at the housing. By use of the conductor connection terminal according to the invention, a very compact spring-loaded connection system for very small conductors is provided, and by means of the first receiving contour there is also an option for latching a swivelable actuating lever to the housing in order to actuate the first clamping spring. The actuating lever allows intuitive operation of the conductor connection terminal by the user.

The actuating lever may be latched to the housing only when necessary, for example, and may optionally be removed from the housing after use. Accordingly, for the actuating lever there is no need for permanent space requirements. This is in turn favorable for miniaturization of the connection system. By latching to the first receiving contour, the actuating lever is fixable to the housing of the conductor connection terminal, thus allowing the necessary swiveling movement for actuating the first clamping spring.

The actuating lever can be swivelably supported on the first receiving contour when it is latched thereto. For example, the first receiving contour itself, together with a fixing contour of the actuating lever latched thereto, may form a swivel bearing which forms a swivel axis for swiveling the actuating lever. Alternatively or additionally, the actuating lever may have a corresponding elasticity via which it is sufficiently flexible to carry out the desired swivel movement. In this case, the actuating lever may be immovably fixed to the first receiving contour, at least to the extent that at that location the swivel movement is not involved.

The housing can have a first conductor insertion opening on a first conductor insertion side, through which the first electrical conductor is insertable to a first clamping point, formed with the first clamping spring, for connecting the first electrical conductor, the first receiving contour being situated on the side of the housing diametrically opposite from the first conductor insertion side. At least the location of the first clamping spring, which is acted on by force by the swivelable actuating lever during manual actuation, may be situated on the side of the housing facing the first conductor insertion opening, or may at least be situated closer to the first conductor insertion opening than to the first receiving contour. In this case, the actuating lever thus overlaps a significant portion of the housing, in particular the predominant portion of the housing in the longitudinal direction. In this way, a large lever arm length may be achieved, even with a highly miniaturized conductor connection terminal with a relatively small housing, which is advantageous for simple, ergonomic actuation of the first clamping spring.

In an area of the first clamping spring, the housing can have a first actuation opening via which, by means of a swivel movement of the actuating lever, the first clamping spring is actuatable by the actuating lever latched to the first receiving contour. The first actuation opening may in particular be situated at the housing on a different side of the housing than the first conductor insertion side, for example at a housing side situated essentially at right angles to the first conductor insertion side. The first actuation opening actuation opening may be designed as a comparatively small opening, so that the electrically conductive components situated in the housing are well protected from environmental influences.

The conductor connection terminal in the housing can have a second spring-loaded clamping connection having a second clamping spring for connecting a second electrical conductor by means of elastic force, on a second conductor insertion side the housing having a second conductor insertion opening through which the second electrical conductor is insertable to a second clamping point, formed with the second clamping spring, for connecting the second electrical conductor, the second conductor insertion side being a side of the housing diametrically opposite from the first conductor insertion side. A highly miniaturized connection terminal in the sense of a feed-through terminal may thus be implemented in a particularly advantageous manner, in which the electrical conductors are inserted on opposite housing sides. The housing, analogously to the first actuation opening, may have a second actuation opening in the area of the second clamping spring, via which the second clamping spring with the actuating lever latched to a second receiving contour is actuatable by means of a swivel movement of the actuating lever. The second actuation opening may in particular be situated at the housing on a different side of the housing than the second conductor insertion side, for example at a housing side situated essentially at right angles to the second conductor insertion side. In particular, the first and second actuation openings may be situated on the same side of the housing. The second actuation opening may be designed as a comparatively small opening, so that the electrically conductive components situated in the housing are well protected from environmental influences.

For latching the actuating lever, the housing can have the first receiving contour on the second conductor insertion side, and has a second receiving contour on the first conductor insertion side, so that the same actuating lever is selectively latchable to the first or the second receiving contour or a first actuating lever is latchable to the first receiving contour, and/or a second actuating lever is latchable to the second receiving contour.

The conductor connection terminal according to the invention is thus in particular universally usable.

The first spring-loaded clamping connection may also have a first busbar section in addition to the first clamping spring. A clamping point for connecting the electrical conductor is then formed between the first busbar section and the first clamping spring, in particular a clamping edge of the first clamping spring. If the conductor connection terminal has the mentioned second spring-loaded clamping connection, this second spring-loaded clamping connection may have a second busbar section in addition to the second clamping spring. A second clamping point for connecting the second electrical conductor is then formed between the second busbar section and the second clamping spring, in particular a clamping edge of the second clamping spring. In an example of the invention, the first busbar section is electrically connected to the second busbar section. In particular, the first busbar section together with the second busbar section may form a shared continuous busbar, i.e., may be formed as a continuous metal part.

The first receiving contour can extend over the entire width of the housing. It is thus made possible, as explained below, for an actuating lever that is latched to the first receiving contour to be displaceable in the width direction of the housing, for example from one spring-loaded clamping connection to the next, or, if multiple housings are joined together in the width direction, to be displaceable from one housing to the next. In particular, a spatial direction situated in parallel to the swivel axis of the actuating lever is understood as a width direction of the housing in which the housing width may be measured.

The conductor connection terminal in a junction direction can have multiple first spring-loaded clamping connections situated next to one another in the housing, into which a first electrical conductor is insertable in each case via a first conductor insertion opening associated with the respective first spring-loaded clamping connection, with the first conductor insertion openings being situated on the same first conductor insertion side of the housing. The conductor connection terminal is thus suitable for connecting a plurality of electrical conductors. The first spring-loaded clamping connections may be electrically separate from one another, or may be partially or completely electrically connected to one another.

If the conductor connection terminal is designed as a feed-through terminal with the second spring-loaded clamping connection, as explained above, for each first spring-loaded clamping connection the conductor connection terminal may have a second spring-loaded clamping connection that is associated with the respective first spring-loaded clamping connection.

The housing of the conductor connection terminal may have a continuous housing in the junction direction which accommodates multiple or all first spring-loaded clamping connections, and optionally also the second spring-loaded clamping connections. The conductor connection terminal may also be designed as a terminal block that can be put together in a modular fashion, in which multiple housing modules are situated next to one another in a disk-like manner in the junction direction and joined together. Such a housing module may then, for example, accommodate a first spring-loaded clamping connection, or a first and a second spring-loaded clamping connection in the case of a feed-through terminal.

The housing in each case can have a first receiving contour that is associated with one of the first spring-loaded clamping connections, the first receiving contours being situated in flush alignment with one another on the same housing side, so that an actuating lever that is latched to a first receiving contour is displaceable in the junction direction from a first receiving contour to another first receiving contour. In this way, multiple or all first spring-loaded clamping connections may be actuated by the same actuating lever. Thus, it is not necessary to use a separate actuating lever for each first spring-loaded clamping connection.

Analogously, the housing in each case may have a second receiving contour that is associated with one of the second spring-loaded clamping connections, the second receiving contours being situated in flush alignment with one another on the same housing side, so that an actuating lever that is latched to a second receiving contour is displaceable in the junction direction from a second receiving contour to another second receiving contour. In this way, multiple or all second spring-loaded clamping connections may be actuated by the same actuating lever. Thus, it is not necessary to use a separate actuating lever for each second spring-loaded clamping connection.

The housing can have a holding contour for mounting a fastening flange on the housing, via which the housing may be fastened to some other object. This has the advantage that the conductor connection terminal may be easily fastened to another object, for example an installation box, a mounting plate, or some other object. The fastening flange may be fastened to the housing or to the holding contour, for example, by latching with one or more detent elements.

The actuating lever can be latchable from the outer side of the housing to the first receiving contour and/or to the second receiving contour. This allows simple and intuitive mounting of the actuating lever on the housing. Likewise, the actuating lever may be easily removed from the housing.

The first and/or second receiving contour can be designed as a concave hollow contour. Accordingly, a fixing contour of the actuating lever designed as a convexly shaped body may be associated with the first and/or second receiving contour. It is also possible to provide the association in the opposite way, i.e., with a convexly shaped first and/or second receiving contour and a fixing contour of the actuating lever, designed as a counterpart thereto, shaped as a concave hollow contour.

The actuating lever, when it is latched to the first or second receiving contour, can be detachable from the first or second receiving contour without damage. This has the advantage that the actuating lever may be subsequently reused, for example at the same conductor connection terminal or at some other conductor connection terminal.

At the first and/or second receiving contour a swivelable actuating lever, which is configured for manual actuation of the first clamping spring, can be latched to the housing. The actuating lever allows simple, intuitive operation when opening the clamping points of the spring-loaded clamping connections of the conductor connection terminal.

The first receiving contour can be situated between the first conductor insertion opening and the side of the housing at which the first actuation opening is present. Analogously, the second receiving contour may be situated between the second conductor insertion opening and the side of the housing at which the second actuation opening is present.

The object stated at the outset is further achieved by an actuating lever for a conductor connection terminal of the above-described type, the actuating lever having a fixing contour that is shaped as the negative of the first receiving contour and latchable to the first receiving contour, the actuating lever also having a manual actuation surface for manually actuating the actuating lever. Furthermore, the actuating lever may have a protruding actuating cam for deflecting the first clamping spring during manual actuation of the actuating lever. The advantages explained above may be achieved here as well. The actuating lever with its fixing contour may be latched to the first receiving contour. In this state, the first clamping spring may be acted on by the actuating lever via the protruding actuating cam and deflected to open the first clamping point. The actuating cam may be guided through the first or second actuation opening of the housing, depending on whether the actuating lever is accommodated at the first or the second receiving contour.

The actuating cam may advantageously protrude on the side of the actuating lever facing away from the manual actuation surface. The actuating cam may in particular protrude in the direction of the housing of the conductor connection terminal when the actuating cam is latched to the first receiving contour. Accordingly, the manual actuation surface is situated on the side of the actuating lever facing away from the housing so that it is manually actuatable in a simple and convenient manner.

The fixing contour can form the swivel axis of the actuating lever when the actuating lever is latched to the first receiving contour. Accordingly, the actuating lever performs a swivel movement about the fixing contour. The actuating lever itself does not have to be deformed, in particular not bent. This allows haptically pleasant, ergonomic operation.

The actuating lever can have an essentially rigid design in the area of its manual actuation surface and/or from the actuation surface to the fixing contour. Accordingly, the actuating lever essentially does not bend during manual actuation. The necessary swivel movement may be achieved via the swivel axis mentioned above.

The object stated at the outset is further achieved by a set made up of at least one conductor connection terminal of the type described above, and at least one actuating lever of the type described above. The advantages explained above may be achieved here as well.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a conductor connection terminal and an actuating lever;

FIG. 2 shows a terminal block made up of multiple terminal modules;

FIG. 3 shows a fastening flange;

FIG. 4 shows the terminal block according to FIG. 2 with an actuating lever and a fastening flange;

FIG. 5 shows the terminal block according to FIG. 2 with an actuating lever and without a closure plate;

FIG. 6 shows an example of a conductor connection terminal with actuating levers;

FIG. 7 shows an example of a conductor connection terminal with actuating levers;

FIG. 8 shows a conductor connection terminal with an actuating ring; and

FIG. 9 shows an actuating ring.

### DETAILED DESCRIPTION

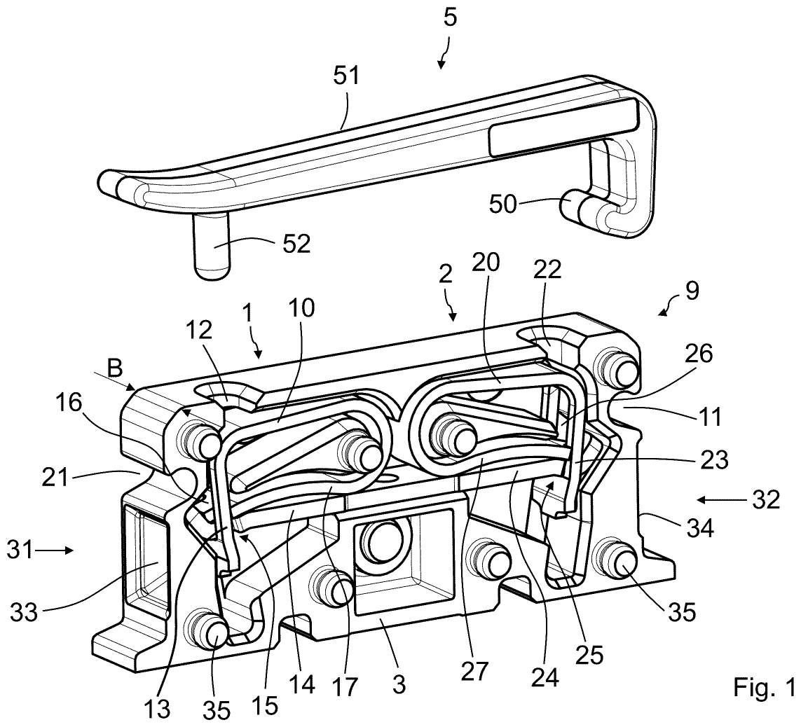

FIG. 1 shows a conductor connection terminal 9 with a housing 3. A first spring-loaded clamping connection 1 and a second spring-loaded clamping connection 2 are situated in the housing 3. The first spring-loaded clamping connection 1 has a first clamping spring 10 and a first busbar section 14. The second spring-loaded clamping connection 2 has a second clamping spring 20 and a second busbar section 24. The first and second busbar sections 14, 24 are designed as a shared continuous busbar; i.e., the first spring-loaded clamping connection 1 is electrically connected to the second spring-loaded clamping connection 2 via this continuous busbar.

In the illustrated example, the first clamping spring 10 and the second clamping spring 20 are designed as tension spring terminals, for example as cage tension springs. The first clamping spring 10 is supported on the first busbar section 14 via a contact leg 17. From the first contact leg 17, the first clamping spring 10 extends over a spring bend toward a first clamping leg 13, which together with the first busbar section 14 forms a first clamping point 15 for connecting a first electrical conductor. The first clamping point 15 is situated on the side of the first busbar section 14 facing away from the first contact leg 17. The first clamping leg 13 has a first window-like opening 16 through which the first busbar section 14 and/or the first contact leg 17 extend(s). When the first clamping spring 10 is mechanically deflected by an actuating element, the first clamping leg 13 is moved downwardly, so that the predominant portion of the first window-like opening 16 is moved to the side of the first busbar section 14 facing away from the first contact leg 17. The first electrical conductor can then be inserted through this first window-like opening 16. When the mechanical action on the first clamping spring 10 ends, it springs back, causing the first electrical conductor that is inserted through the first window-like opening 16 to be fixed to the first clamping point 15 by means of the first clamping leg 13.

The second clamping spring 20 is supported on the second busbar section 24 via a contact leg 27. From the second contact leg 27, the second clamping spring 20 extends over a spring bend toward a second clamping leg 23, which together with the second busbar section 24 forms a second clamping point 25 for connecting a second electrical conductor. The second clamping point 25 is situated on the side of the second busbar section 24 facing away from the second contact leg 27. The second clamping leg 23 has a second window-like opening 26, through which the second busbar section 24 and/or the second contact leg 27 extend(s). When the second clamping spring 20 is mechanically deflected by an actuating element, the second clamping leg 23 is moved downwardly, so that the predominant portion of the second window-like opening 26 is moved to the side of the second busbar section 24 facing away from the second contact leg 27. The second electrical conductor can then be inserted through this second window-like opening 26. When the mechanical action on the second clamping spring 20 ends, it springs back, causing the second electrical conductor that is inserted through the second window-like opening 26 to be fixed to the second clamping point 25 by means of the second clamping leg 23.

On a first conductor insertion side 31 the housing 3 has a first conductor insertion opening 33 through which the first electrical conductor may be inserted into the housing 3 and guided to the first clamping point 15. On a second conductor insertion side 32 the housing 3 has a second conductor insertion opening 34 through which the second electrical conductor may be inserted into the housing 3 and guided to the second clamping point 25.

On the side of the housing 3 facing away from the first conductor insertion side 31, i.e., in the present case on the second conductor insertion side 32, the housing 3 on its outer side has a first receiving contour 11 to which a swivelable actuating lever 5 may be latched. On the first conductor insertion side 31, the housing 3 on its outer side has a second receiving contour 21 to which a swivelable actuating lever 5 may be latched. As is apparent, the first receiving contour 11 and/or the second receiving contour 21 may extend over the entire housing width B.

The actuating lever 5 has a fixing contour 50 that is shaped as a negative to the first receiving contour 11 and latchable to the first receiving contour 11. The actuating lever 5 also has a manual actuation surface 51 for manually actuating the actuating lever 5, and a protruding actuating cam 52 for deflecting the first or second clamping spring 10, 20 upon manual actuation of the actuating lever 5. The actuating cam 52 protrudes on the side of the actuating lever 5 facing away from the manual actuation surface 51.

By means of the actuating lever 5, upon manual actuation, for example the first clamping spring 10 may be mechanically deflected; i.e., as mentioned, the first clamping leg 13 may be moved downwardly. For this purpose, the actuating lever 5 with its fixing contour 50 is to be latched to the first receiving contour 11. If the actuating lever 5 is then acted on by a pressure force at its manual actuation surface 51, the actuating cam 52 protruding on the opposite side is guided through a first actuation opening 12 of the housing 3, and presses the clamping leg 13 downwardly. Alternatively, the actuating lever 5 may also be latched to the second receiving contour 21. The second clamping spring 20 may then be similarly actuated via the actuating cam 52, which then protrudes through a second actuation opening 22 of the housing 3.

The conductor connection terminal 9 is designed as a terminal module which may be modularly put together with further terminal modules of the same design to form a terminal block. For this purpose, the housings 3 each have journals 35 protruding on one side, which may be engaged with depressions situated on an opposite side of the housing 3.

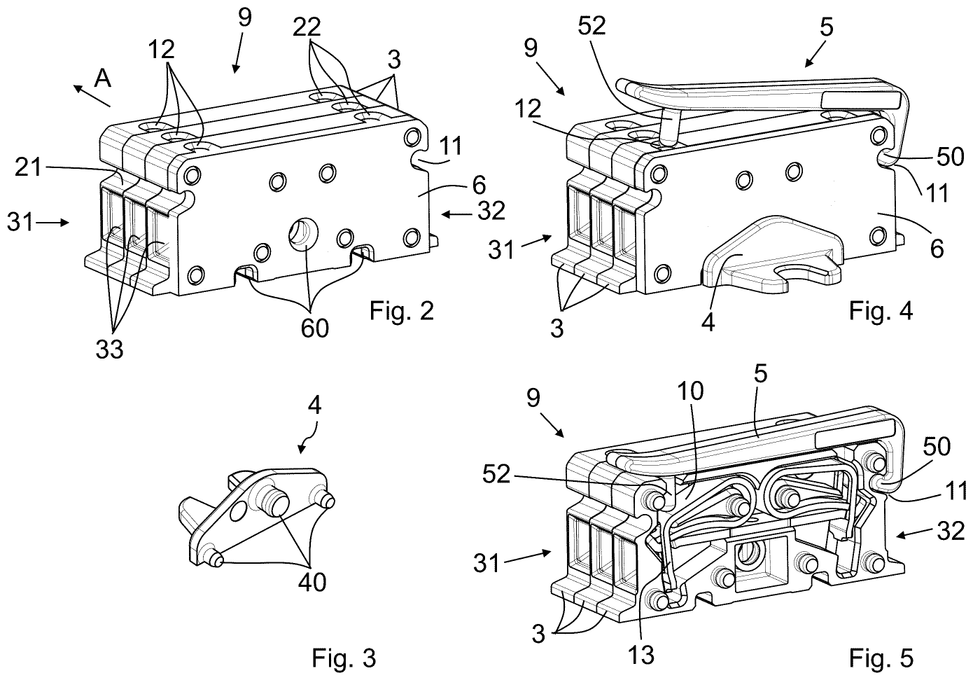

FIG. 2 shows three conductor connection terminals 9 of the type illustrated in FIG. 1, which are latched together to form a terminal block. The conductor connection terminals 9 are arranged side by side in a junction direction A. At the last conductor connection terminal 9, to cover its open housing side the terminal block formed in this way is provided with a closure plate 6 which may be latched using the journals 35, similarly to how the housings 3 are latched together.

It is also apparent in FIG. 2 that the housings 3 and/or the closure plate 6 have/has a holding contour 60 for mounting a fastening flange on the housing 3 or on the closure plate 6.

FIG. 3 shows such a fastening flange 4, which may be mounted on the holding contour 60. The fastening flange 4 has retaining elements 40 shaped as a negative contour with respect to the holding contour 60, for example in the form of detent elements.

FIG. 4 illustrates how a fastening flange 4 of the type illustrated in FIG. 3 may be fastened to the terminal block according to FIG. 2.

It is also apparent in FIG. 4 how an actuating lever 5 is latched to the housing 3, for example to the first receiving contour 11. The actuating cam 52 of the actuating lever 5 is now situated in the area of a first actuation opening 12.

FIG. 5 shows the terminal block according to FIG. 4, with the closure plate 6 together with the fastening flange 4 removed to clarify the actuation of the first clamping spring 10. The actuating lever 5 is now in a manually actuated state in which the actuating cam 52 is guided far through the first actuation opening 12, and has thus moved the first clamping leg 13 downwardly so that an electrical conductor may be guided through the first window-like opening 16. When the actuating force on the actuating lever 5 is discontinued, the clamping spring 10 springs back, at least partially, into the position illustrated in FIG. 1 until the connected electrical conductor is fixed to the first clamping point 15 at the first busbar section 14.

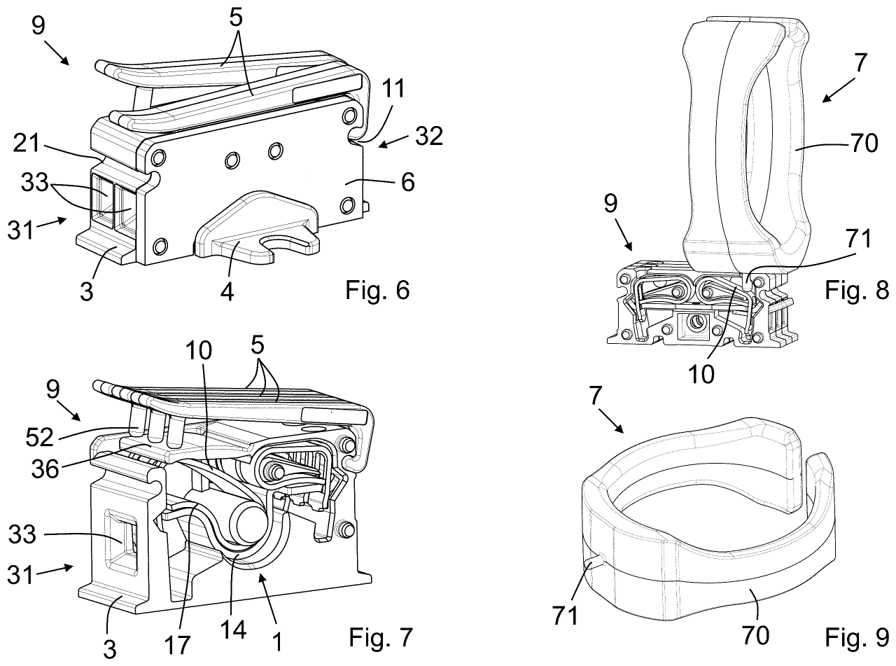

The conductor connection terminal according to the invention may be varied in many respects. FIG. 6 shows an example with a housing 3 having two first conductor insertion openings 33, arranged next to one another, on the first conductor insertion side 31. However, the housing 3 is designed as a continuous housing, i.e., not as illustrated in FIG. 2 with two housings put together in a modular fashion. A first spring-loaded clamping connection may be associated with each of the first conductor insertion openings 33, wherein the first spring-loaded clamping connections may be electrically connected to one another, for example due to the presence of a continuous first busbar section for both first spring-loaded clamping connections. The first spring-loaded clamping connections may in turn be actuated by an actuating lever 5 that is latched to the first receiving contour 11. FIG. 6 shows an example in which two actuating levers 5 are latched side-by-side to the first receiving contour 11. One actuating lever 5 is in the manually actuated state, and the other is in the unactuated state.

FIG. 7 shows an example in which the conductor connection terminal 9 on the first conductor insertion side 31 has only one first conductor insertion opening 33, with which a first spring-loaded clamping connection 1 with a first clamping spring 10 is associated, the first clamping spring being much wider than the clamping springs shown in the previous illustrations. The first clamping spring 10 may extend, for example, in the width direction over a width of three first spring-loaded clamping connections of the type illustrated in FIG. 2, or may extend over any other number of spring-loaded clamping connections. The first clamping spring 10, which due to its size requires a greater actuating force, may be actuated by multiple actuating levers 5 that are latched to the housing 3, for example by three actuating levers 5 situated side by side in the illustrated example. The first clamping spring 10 may be acted on directly by the actuating cams 52, or, as illustrated in FIG. 7, may be acted on by a force transmission element 36 situated in between, which, for example, may be designed as an elastically deflectable tab and formed in one piece with the material of the housing 3. The transmission of force to the clamping spring 10 may thus be equalized by the three individual actuating levers 5.

It is also apparent in FIG. 7 that situated on the second conductor insertion side 32, diametrically opposite from the first conductor insertion side 31, are multiple second spring-loaded clamping connections 2, each having a smaller second clamping spring 20 compared to the first clamping spring 10 (in the present example, three second clamping springs 20). The second spring-loaded clamping connections 2 are electrically connected to the first spring-loaded clamping connection 1 via a shared busbar. In this design, the conductor connection terminal 9 may be used in the manner of a distributor terminal.

For highly miniaturized conductor connection terminals, it may also be helpful to carry out the actuation of the spring-loaded clamping connections not by using an actuating lever 5, but, rather, as illustrated in FIG. 8, by using a separate actuating element in the form of an actuating ring 7 for this purpose. The actuating ring 7 has a ring-shaped section 70 on which an actuating cam 71 is integrally formed on the outer side. The actuating ring 7 may be placed over a finger or thumb, for example, and thus conveniently used for actuating spring-loaded clamping connections of miniaturized conductor connection terminals. FIG. 9 shows the actuating ring 7 in a different view as a separate part. The ring-shaped section 70 may in particular have a design that is not completely annularly closed, and instead may have an interruption on one side, for example on the side facing away from the actuating cam 71.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor connection terminal comprising:
a housing; and
at least one first spring-loaded clamping connection arranged in the housing, having a first clamping spring to connect a first electrical conductor via elastic force,
wherein the housing, on its outer side, has a first receiving contour to which a swivelable actuating lever, which is configured for manual actuation of the first clamping spring, is latchable at the housing.

2. The conductor connection terminal according to claim 1, wherein the actuating lever is swivelably supported on the first receiving contour when it is latched thereto.

3. The conductor connection terminal according to claim 1, wherein the housing has a first conductor insertion opening on a first conductor insertion side, through which the first electrical conductor is insertable to a first clamping point, formed with the first clamping spring, to connect the first electrical conductor, and wherein the first receiving contour is arranged on a side of the housing diametrically opposite from the first conductor insertion side.

4. The conductor connection terminal according to claim 1, wherein in an area of the first clamping spring, the housing has a first actuation opening via which, by a swivel movement, the first clamping spring is actuatable by the actuating lever latched to the first receiving contour.

5. The conductor connection terminal according to claim 1, wherein the conductor connection terminal in the housing has a second spring-loaded clamping connection having a second clamping spring to connect a second electrical conductor via elastic force on a second conductor insertion side the housing having a second conductor insertion opening through which the second electrical conductor is insertable to a second clamping point, formed with the second clamping spring to connect the second electrical conductor, the second conductor insertion side being a side of the housing diametrically opposite from the first conductor insertion side.

6. The conductor connection terminal according to claim 5, wherein, for latching the actuating lever, the housing has the first receiving contour on the second conductor insertion side and has a second receiving contour on the first conductor insertion side so that the same actuating lever is selectively latchable to the first or second receiving contour or so that a first actuating lever is latchable to the first receiving contour and/or a second actuating lever is latchable to the second receiving contour.

7. The conductor connection terminal according to claim 1, wherein the first receiving contour extends over the entire width of the housing.

8. The conductor connection terminal according to claim 1, wherein the conductor connection terminal, in a junction direction, has multiple first spring-loaded clamping connections arranged next to one another in the housing, into which a first electrical conductor is insertable via a first conductor insertion opening associated with the respective first spring-loaded clamping connection with the first conductor insertion openings being arranged on the same first conductor insertion side of the housing.

9. The conductor connection terminal according to claim 7, wherein the housing in has a first receiving contour that is associated with one of the first spring-loaded clamping connections, wherein the first receiving contours are arranged in flush alignment with one another on the same housing side so that an actuating lever that is latched to a first receiving contour is displaceable in the junction direction from a first receiving contour to another first receiving contour.

10. The conductor connection terminal according to claim 1, wherein the housing has a holding contour to mount a fastening flange on the housing, via which the housing is adapted to be fastened to some other object.

11. The conductor connection terminal according to claim 1, wherein the actuating lever is latchable from the outer side of the housing to the first receiving contour.

12. The conductor connection terminal according to claim 1, wherein the first receiving contour is designed as a concave hollow contour.

13. The conductor connection terminal according to claim 1, wherein the actuating lever when it is latched to the first receiving contour and is detachable from the first receiving contour without damage.

14. The conductor connection terminal according to claim 1, wherein at the first receiving contour a swivelable actuating lever, which is configured for manual actuation of the first clamping spring, is latched to the housing.

15. An actuating lever for the conductor connection terminal according to claim 1, wherein the actuating lever has a fixing contour that is shaped as a negative to the first receiving contour and latchable to the first receiving contour, and wherein the actuating lever also has a manual actuation surface for manual actuation of the actuating lever.

16. The actuating lever according to claim 15, wherein the actuating lever has a protruding actuating cam to deflect the first clamping spring during manual actuation of the actuating lever.

17. The actuating lever according to claim 15, wherein the fixing contour forms the swivel axis of the actuating lever when the actuating lever is latched to the first receiving contour.

18. The actuating lever according to claim 15, wherein the actuating cam protrudes on the side of the actuating lever facing away from the manual actuation surface.

19. The actuating lever according to claim 15, wherein the actuating lever has an essentially rigid design in the area of its manual actuation surface and/or from the actuation surface to the fixing contour.

20. A set made up of at least one conductor connection terminal according to claim 1 and at least one actuating lever.
